(19) United States
(12) Patent Application Publication
(10) Pub. No.: US 2024/0196456 A1
(43) Pub. Date: Jun. 13, 2024

(54) METHOD FOR CONTROLLING A MULTI-HOP TRANSMISSION IN A WIRELESS COMMUNICATION NETWORK, METHOD FOR PROCESSING A MULTI-HOP TRANSMISSION, CORRESPONDING DEVICES, SYSTEM AND COMPUTER PROGRAMS

(71) Applicant: ORANGE, Issy-les-Moulineaux (FR)

(72) Inventor: Jean-Marc Kelif, CHÂTILLON CEDEX (FR)

(21) Appl. No.: 18/551,042

(22) PCT Filed: Mar. 25, 2022
(86) PCT No.: PCT/FR2022/050557

§ 371 Date: Sep. 18, 2023

(30) Foreign Application Priority Data
Mar. 26, 2021 (FR) 2103138

(51) Int. Cl. H04W 76/14; H04W 88/04

(52) U.S. Cl. CPC H04W 76/14; H04W 88/04

(57) ABSTRACT

A method of controlling a multi-hop transmission in a wireless communication network implementing plural relay nodes. The method includes: obtaining for a current relay node, a current strength ratio between a strength of the radio signal and a noise and interference strength, received and measured by the current relay node; determining a current intermediate transmission delay of a data volume transmitted by a source node, which is a function of the current strength ratio, a received data volume and a transmission bandwidth; estimating an overall transmission delay of the data volume from the source node to a final relay node at a number of hops N, with N being greater than or equal to i, based on the current intermediate transmission delay and a previously determined intermediate delay; and, if the estimated overall transmission delay reaches or exceeds a maximum delay, modifying a multi-hop transmission configuration of the system.

### CROSS-REFERENCE TO RELATED APPLICATIONS

This Application is a Section 371 National Stage Application of International Application No. PCT/FR2022/050557, filed Mar. 25, 2022, which is incorporated herein by reference in its entirety and published as WO 2022/200746 A1 on Sep. 29, 2022, not in English.

### TECHNICAL FIELD OF THE DISCLOSURE

The field of the disclosure is that of a wireless communication network, for example of the cellular type, comprising a plurality of relay nodes configured to receive a radio signal carrying a useful data volume transmitted by a source node in said network, amplify it and relay it in whole or in part, or even complete it.

In particular, the disclosure relates to the control of a maximum transmission delay of such a data volume in said network.

### PRIOR ART

A wireless communication network, for example of the cellular radio type, is known in which a source node, for example a mobile terminal, for example in a vehicle, transmits a radio signal and this signal is relayed by several “Amplify and Forward” relay nodes before reaching its destination. This is also known as multi-hop transmission, where each hop refers to the reception, amplification and retransmission of the radio signal by a relay node. It should be noted that the destination of the radio signal transmitted by the source node is not necessarily known to the source node in advance. The radio signal may be transmitted to a particular node, but it may also be transmitted to one or more nodes, for example nodes verifying a predetermined condition such as being located within a number of hops from the source node that is less than or equal to a given number, or within a given geographical radius.

Such a relay node is configured to amplify the total strength of the received signal before retransmitting it to a following relay node. The strength received by the destination node is made up of the useful signal emitted by the source node and a non-useful strength due to the interference undergone by the signal at each hop and the undifferentiated amplification of the interference and the useful signal by each relay node. This interference comes from all the nodes of the network transmitting at the same frequency as the transmitted signal.

One use case for multi-hop transmissions involves motorised vehicles, such as cars, travelling in a line on a road. The first car transmits information carried by a radio signal to the one following it. For example, information relating to the control of the vehicle, such as information relating to a braking or change of steering command. The second car uses, if appropriate, the command embedded in the radio signal it has received, amplifies it and retransmits it to the next car in line, and so on. In this case, the maximum number of possible cars likely to receive and retransmit the signal is not necessarily known a priori.

However, the information transmitted by the source node and carried by the radio signal may have a limited validity period: for example, it can be considered that information relating to the control of a vehicle that is travelling on a road, such as a braking command, may become obsolete after a few seconds or at the end of the event that triggered the control of the vehicle, as notably when a traffic jam having triggered the braking command is cleared. Some relay nodes may therefore receive information sent by the source node that is no longer relevant and no longer needs to be processed locally and/or retransmitted.

Another use case may be to select a route from a source node in an adhoc network to a determined destination node in this network in order to transmit information to it (for example, a command as mentioned above or any other type of information). As in the previous use case, time constraints may be imposed. For example, the information transmitted may be of limited duration, or for reasons of performance and user experience, it may be desirable for the information to reach the destination node as rapidly as possible via the adhoc network, or via a limited number of relay nodes.

However, the operating principle of multi-hop transmissions makes it difficult to determine the overall transmission delay of the radio signal from a source node to a particular destination node, notably due to the fact that the interference received at each relay node is amplified at the same time as the useful signal.

### SUMMARY

An exemplary aspect of the disclosure responds to this need by proposing a method for controlling a multi-hop transmission in a wireless communication network, said transmission being implemented by a system comprising a source node and a plurality of relay nodes configured to receive, amplify and retransmit a radio signal transmitted by the source node.

Said method comprises, for a relay node of the current system, placed at i hops from the source node, with i a non-null integer:
obtaining for said current relay node a current strength ratio between a strength of the radio signal and a noise and interference strength received by said current relay node;
determining a current intermediate transmission delay of useful data carried by said radio signal between said source node or a previous relay node located at i−1 hops and said current relay node, said current intermediate delay being a function of said obtained current strength ratio, a useful data volume received by said current relay node and a transmission bandwidth of this volume between the source node or the previous relay node and said current relay node;
estimating an overall transmission delay of the radio signal from the source node to a final relay node located at a number of hops N, with N an integer greater than or equal to i, at least from the determined current intermediate transmission delay and at least one intermediate delay previously determined for a relay node located at i−1 hops or less from the source node; and
if the estimated overall transmission delay reaches or exceeds a given maximum delay, modifying a multi-hop transmission configuration of said system.

Thus, an aspect of the disclosure proposes a completely new and inventive approach to the management of a multi-hop transmission in a wireless communication network, which consists in estimating, during the transmission of useful data emitted by a source node participating in this transmission, an overall transmission delay of these data to a relay node placed at N hops from the source node, at least on the basis of strength information received from the relay nodes that have already relayed the radio signal received. According to an aspect of the disclosure, when the estimated delay exceeds an authorised maximum delay, the multi-hop transmission configuration of the system is modified. Such a configuration modification may relate to parameters for selecting a route or for selecting a new route to a destination node from a plurality of routes, new rules defining the conditions for retransmitting all or part of the useful data volume received by a relay node, for example as a function of a number of hops separating it from the source node, stopping retransmission beyond a relay node located at a given number of hops, and so on. It can be applied immediately to the current transmission or to a transmission of a next data volume by the communication system. It can be transmitted in a specific action message or integrated into the next data volume transmitted by the source node. It may relate to one or more of the communication nodes of the system.

In this way, an aspect of the disclosure makes it possible to check that the relay nodes of the multi-hop transmission system satisfy a predetermined delay constraint.

According to one aspect of the disclosure, the estimation of the overall transmission delay of said radio signal from the source node to a final relay node placed at a number of hops N is implemented once the strength ratios have been obtained and the intermediate transmission delays have been determined for the plurality of relay nodes participating in the transmission and the selected configuration is applied for the transmission of a next radio signal by the source node.

According to this method, the overall transmission delay of a previous or pilot data volume to a recipient located at N hops is estimated upstream and it is verified that a maximum delay constraint is satisfied. If this is not the case, the configuration of at least one communication node participating in the transmission is modified. For example, it is the source node that must modify its route selection configuration, such that the route chosen to carry the next data volume is faster and, for example, includes fewer relay nodes.

According to another aspect of the disclosure, the estimation of the overall transmission delay of said radio signal from the source node to a final relay node located at a number of hops N is implemented following the strength ratio being obtained and the determination of the intermediate transmission delay for the current relay node, and the modification of the configuration comprises the sending of an action message comprising at least the modified configuration and an order for the application of said configuration by at least one relay node located at i+1 hops and more from the source node.

According to this other embodiment, the overall transmission delay of the data volume emitted by the source node is estimated on the fly during its transmission. Transmission control is exercised by commanding one or more relay nodes located downstream to modify their multi-hop transmission configuration immediately. For example, the modification relates to one or more rules relating to the processing of received data before it is retransmitted. For example, the processing applied comprises selecting part of the data or compressing the received data. Alternatively, the modification may involve stopping or disabling the retransmission by relay nodes located downstream or from a given number of hops.

Advantageously, when N is greater than i, said method comprises the prediction of at least one intermediate delay for at least one next relay node, placed between i+1 and N hops, at least from the current strength ratio or from a strength ratio stored in memory for said next relay node, and the estimation of the overall transmission delay takes into account the predicted intermediate delays.

To estimate on the fly an overall transmission delay for all or part of a data volume up to a relay node located further downstream, i.e. at a greater number of hops from the source node than from the current relay node, there are not all the necessary intermediate transmission delays. Faced with this problem, an aspect of the disclosure proposes to make the realistic assumption that strength ratios already obtained for the data volume currently being transmitted, or for a data volume previously transmitted, make it possible to predict the strength ratios of subsequent relay nodes that have not yet been obtained. One advantage is that it is possible to determine in advance whether the relay node at i+1 hops and more can relay the data to the relay located N hops from the source node without exceeding the maximum authorised transmission delay and, if this is not the case, to modify their multi-hop transmission configuration in time, that is before the first of them starts to receive, amplify and relay the data in question.

Advantageously, the method comprises determining a maximum number of relays corresponding to a maximum value of the number of hops N at which the final relay node is located, such that a predetermined condition is satisfied, said condition being that the estimated overall transmission delay for a number of hops N equal to the maximum number of relays NMax does not reach the maximum delay and the estimated overall transmission delay for a number of hops equal to NMax+1 reaches or exceeds said maximum delay; and
the modified configuration includes the maximum number of relays and a rule for disabling retransmission of the radio signal received from the source node for a relay node located at a hop number greater than or equal to said maximum number of relays.

In this way, the relay nodes located at a hop number greater than or equal to the NMax number are reconfigured to disable retransmission of the data signal from the source node, which guarantees respect of the constraint on the maximum authorised transmission delay.

According to another aspect of the disclosure, the relay nodes of said plurality transmit on the same frequency band and the estimation of the overall transmission delay comprises a summing of the intermediate transmission delays between the relay nodes placed at N hops and less from the source node.

Advantageously, the overall transmission delay is expressed as follows:

$$DTG = {\sum }_{i = 1}^{N} \frac{{Vol}_{i}}{{W}_{i}} \frac{1}{{log}_{2} ( 1 + {SINR}_{i} )}$$

where Voli is the useful data volume received by the current relay node (ERi);
Wi the transmission bandwidth available at the current relay node (ERi);
N the number of hops at which the final relay node is placed; and
SINRi represents the signal to interference+noise ratio at the relay node placed at i hops for the radio signal received from the previous relay node (ERi−1).

According to yet another aspect of the disclosure, the determination of the maximum number of relays comprises the iteration of a step of incrementing the number of hops N by one unit, of the step of estimating an overall transmission delay for the final relay node, as long as the predetermined condition is not met.

The maximum number of relays is obtained numerically using a simple algorithm that is easy to run on a computer. Of course, other algorithms may be considered.

According to another aspect of the disclosure, for i equal to 1, the intermediate transmission delays of the relay nodes located 2 hops and more from the source node are predicted as equal to the current strength ratio and the overall transmission delay up to a final relay node located at N hops is calculated from a signal-to-noise ratio at the relay node located at i hops defined as follows:

$$\\ D T G = {\sum }_{i = 1}^{N} \frac{{Vol}_{i}}{{W}_{i}} \frac{1}{{{log}_{2} ( 1 + S I N {R}_{i} )}^{{}_{} ′}} where S I N {R}_{i} = \frac{1}{{ζ}^{{}_{} i} - {1}^{′}}$$

Voli is the data volume received by the current relay node, Wi is the transmission bandwidth at the current relay node, and

$$\\ ζ = 1 + \frac{1}{θ}$$

where θ is the strength ratio obtained by the relay node placed at one hop from the source node.

According to this method, transmission control is carried out while the current data volume is being transmitted, but as soon as the strengths measured by the first relay node are received, assuming that all the subsequent relay nodes have the same strength ratio as it. One advantage is that the overall transmission delay DTG_{N} to the final relay node of rank N can be calculated relatively simply and quickly.

According to yet another aspect of the disclosure, the overall transmission delay is estimated as the intermediate transmission delay of the relay node having the maximum value and in that the authorised maximum number is calculated as follows:

$$\\ {N}_{Max} = ⌊ \frac{a - log 2 ( {2}^{{}_{} a} - 1 )}{log 2 ( ξ )} ⌋$$

with a defined by the following formula:

$$\\ a = \frac{Vol}{{WD}_{max}} ,$$

└ ┘ designates the integer part, where Dmax represents the maximum value of the overall transmission delay, Vol the useful data volume carried by the radio signal transmitted by the source node and relayed by the relay nodes, and W the transmission bandwidth available for the multi-hop transmission.

One advantage is that it provides a relatively simple analytical expression for the maximum number of hops allowed. This expression of the overall transmission delay is particularly applicable when the relay nodes of the system transmit on separate frequency bands in half-duplex or when they share the same frequency band but transmit and receive simultaneously (full duplex).

An aspect of the disclosure also relates to a computer program product comprising program code instructions for implementing a control method of a multi-hop transmission according to the invention, as described previously, when it is executed by a processor.

An aspect of the disclosure also relates to a computer-readable storage medium on which the computer programs as described above are recorded.

Such a storage medium can be any entity or device able to store the program. For example, the medium can comprise a storage means, such as a ROM, for example a CD-ROM or a microelectronic circuit ROM, or a magnetic recording means, for example a USB flash drive or a hard drive.

On the other hand, such a storage medium can be a transmissible medium such as an electrical or optical signal, that can be carried via an electrical or optical cable, by radio or by other means, so that the computer program contained therein can be executed remotely. The program according to aspect of the disclosure can be downloaded in particular on a network, for example the Internet network.

Alternatively, the storage medium can be an integrated circuit in which the program is embedded, the circuit being adapted to execute or to be used in the execution of the above-mentioned control method.

An aspect of the disclosure also relates to a device for controlling a multi-hop transmission in a wireless communication network, said transmission being implemented by a system comprising a source node and a plurality of relay nodes configured to receive, amplify and retransmit a radio signal transmitted by the source node.

Said device is configured to implement, for a relay node of the current system, placed at i hops from the source node, with i a non-null integer:
obtaining for said current relay node a current strength ratio between a strength of the radio signal and a noise and interference strength received and measured by said current relay node;
determining a current intermediate transmission delay of useful data carried by said radio signal between said source node or the previous relay node and said current relay node, said current intermediate delay being a function of said current strength ratio obtained, a volume of useful data received by said current relay node and a transmission bandwidth of this volume between the source node or the previous relay node and said current relay node;
estimating an overall transmission delay of the radio signal from the source node to a final relay node located at a number of hops N, with N an integer greater than or equal to i, at least from the determined current intermediate transmission delay and at least one intermediate delay previously determined;
if the estimated overall transmission delay reaches or exceeds a given maximum delay, modifying a multi-hop transmission configuration of said system.

Advantageously, said device is configured to implement the above-mentioned multi-hop transmission control method, according to its different embodiments.

Advantageously, said device can be integrated into a node of the communication network. This is, for example, the source node or a relay node of the system. It may also be another communication node of the network, such as a base station to which the system nodes are attached.

Correspondingly, an aspect of the disclosure relates to a method for processing a multi-hop transmission in a wireless communication network, said transmission being implemented by a system comprising a source node and a plurality of relay nodes configured to receive, amplify and retransmit a radio signal transmitted by the source node.

Said method comprises, for a relay node of the current system, placed at i hops from the source node, with i a non-null integer:
transmitting to a control device of the wireless communication network at least one strength of a radio signal and a noise and interference strength received by said current relay node; and
receiving from said control device of an action message comprising at least one multi-hop transmission configuration modification of said system and an order to apply said modification.

With an aspect of the disclosure, the relay node located at i hops from the source node for the transmission of a data volume transmitted by the source node to a destination node, is configured to modify its multi-hop transmission configuration in accordance with the instructions of the control device.

According to one aspect of the disclosure, said modified configuration comprises at least a maximum number of relays greater than or equal to i and a prohibition on retransmitting the radio signal received from the source node, and the application order is intended for relay nodes located at a number of hops greater than or equal to said maximum number of relays.

The advantage of this embodiment is to limit the number of hops allowed within the system to retransmit the data from the source node, to a determined maximum number to guarantee the maximum delay constraint.

According to another aspect of the disclosure, the method comprises deciding to execute the application order included in the message when the number of hops i from the relay node to the number N received is greater than or equal to the number N received.

One advantage is that when the action message is intended for a group address, the relay node determines whether to perform the action in the message by comparing the number of hops i separating it from the source node with the maximum number of relays NMax specified in the action message.

An aspect of the disclosure also relates to a computer program product comprising program code instructions for implementing a processing method of a multi-hop transmission according to the disclosure, as described previously, when it is executed by a processor.

An aspect of the disclosure also relates to a computer-readable storage medium on which the computer programs as described above are recorded.

Such a storage medium can be any entity or device able to store the program. For example, the medium can comprise a storage means, such as a ROM, for example a CD-ROM or a microelectronic circuit ROM, or a magnetic recording means, for example a USB flash drive or a hard drive.

On the other hand, such a storage medium can be a transmissible medium such as an electrical or optical signal, that can be carried via an electrical or optical cable, by radio or by other means, so that the computer program contained therein can be executed remotely. The program according to an aspect of the disclosure can be downloaded in particular on a network, for example the Internet network.

Alternatively, the storage medium can be an integrated circuit in which the program is embedded, the circuit being adapted to execute or to be used in the execution of the above-mentioned processing method.

An aspect of the disclosure also relates to a device for processing a multi-hop transmission in a wireless communication network, said transmission being implemented by a system comprising a source node and a plurality of relay nodes of the wireless communication network, configured to receive, amplify and retransmit a radio signal transmitted by the source node.

Said device is configured to implement, for a relay node of the current system, placed at i hops from the source node, with i a non-null integer:
transmitting to a control device of the wireless communication network at least one strength of a radio signal and a noise and interference strength received and measured by said current relay node; and
receiving from said control device of an action message comprising at least one modification of a multi-hop transmission configuration of said system and an order to apply said modification.

Advantageously, said device is configured to implement the above-mentioned processing method, according to its different embodiments.

Advantageously, said device is integrated in a relay node of the system. Correspondingly, an aspect of the disclosure also relates to relay node of a wireless communication network, configured to receive, amplify and retransmit a radio signal transmitted by a source node and received from the source node or from a previous relay node, said relay node comprising the aforementioned processing device.

An aspect of the disclosure also relates to a source node in a wireless communication network, said source node being configured to transmit in said communication network a radio signal and comprising said aforementioned control device.

An aspect of the disclosure also relates to a communication node in a wireless communication network comprising the aforementioned control device.

Finally, an aspect of the disclosure relates to a multi-hop transmission system in a wireless communication network, comprising a source node configured to transmit in said network a radio signal and a plurality of relay nodes configured to receive, amplify and retransmit the radio signal transmitted by the source node, the system comprising the aforementioned control device and said relay nodes comprising the aforementioned processing device.

### BRIEF DESCRIPTION OF THE FIGURES

Other purposes, features and advantages of aspects of the disclosure will become more apparent upon reading the following description, hereby given to serve as an illustrative and non-restrictive example, in relation to the figures, among which:

FIG. 1: shows an example of the architecture of a multi-hop transmission system implemented in a wireless communication network comprising a source node, a plurality of relay nodes and a device for controlling said transmission, configured to control said plurality of relay nodes in accordance with an aspect of the disclosure;

FIG. 2: diagrammatically illustrates an example of the architecture of the device for controlling a multi-hop transmission implemented in a wireless communication network by said system and of a relay node of said system, integrating a device for processing the multi-hop transmission, according to one aspect of the disclosure;

FIG. 3: describes in the form of a flowchart the steps of a method for controlling a multi-hop transmission, according to an aspect of the disclosure;

FIG. 3: describes in the form of a flowchart the steps of a method for processing a multi-hop transmission by a relay node of said plurality, according to an aspect of the disclosure;

FIG. 5: describes an example of a hardware structure of a device for controlling a multi-hop transmission implemented in a wireless communication network according to an aspect of the disclosure; and

FIG. 6: describes an example of a hardware structure of a device for processing a multi-hop transmission implemented in a wireless communication network according to an aspect of the disclosure.

### DETAILED DESCRIPTION OF ILLUSTRATIVE ASPECTS OF THE DISCLOSURE

The principle of an aspect of the disclosure consists in estimating an overall transmission delay of a data signal by a multi-hop transmission in a wireless communication network, said transmission being implemented by a system comprising a source node and a plurality of relay nodes configured to receive, amplify and retransmit a radio signal transmitted by the source node, and in verifying that this overall transmission delay is less than or equal to an authorised maximum delay. Such an estimate is based on at least one strength ratio between a strength of a radio signal and an interference and noise strength received by a relay node of the system, said relay node being located at i hops from the source node, with i less than or equal to N and at least one intermediate delay previously determined for a relay node located at i−1 hops or less from the source node.

When the overall estimated transmission delay reaches or exceeds a maximum delay, a modification of the multi-hop transmission configuration of the system is decided and applied, for example by sending an action message to the relevant communication nodes, which can be the source node itself and/or one or more relay nodes in the system.

This modified configuration can be applied to the transmission of the current radio signal or to that of a next radio signal.

The configuration modification defines new rules or parameters for processing a data volume to be transmitted or retransmitted by these communication nodes. For example, new rules or parameters for selecting a route to carry the useful data volume to one or more destination nodes. It can also define rules for processing the useful data volume by a relay node, including, for example, a compression of such data or a deletion of data specifically intended for the current relay node, leading to retransmission of a sub-volume of the received data volume. If the data includes commands, these processing rules can define a conversion to more basic commands, which are therefore more economical in terms of transmission resources. The configuration modification can also define a maximum number of relays and processing rules relating to this maximum number of relays, such as a prohibition on retransmitting the received data when this number of relays is reached or exceeded, or even the search for a route comprising a number of relays less than or equal to this maximum number.

An aspect of the disclosure has a particularly interesting application in managing queues of vehicles, at least partially autonomous. In this case, each vehicle incorporates a mobile terminal node, configured to transmit to the vehicles in proximity information relating to vehicle control commands, for example when changing direction, braking, etc.

Of course, the disclosure is not limited to this example of a use case, but could also be applied in other contexts, as for example to a system of interconnected production machines in a factory or, more generally, to any system of connected objects.

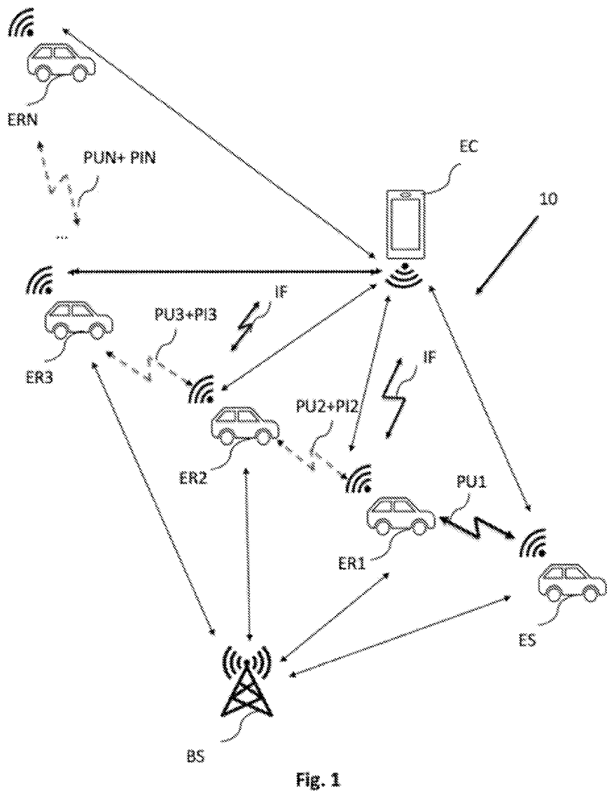

In relation to FIG. 1, an example of the architecture of a system 10 for managing a multi-hop transmission in a wireless communication network, for example cellular radio, implementing a source node ES, for example a first vehicle carrying a mobile communication node and transmitting a signal carrying a useful data volume Vol in the network, which is then relayed by a plurality of relay nodes ER1-ERN, for example other vehicles each carrying a mobile communication node, is now presented. For example, it is assumed that all the mobile communication nodes in these vehicles are attached to a same base station BS.

As illustrated in FIG. 1, the system 10 according to an aspect of the disclosure comprises the source node ES, the plurality of relay nodes ER1-ERN and a communication node EC, configured to control the processing of the multi-hop transmission by the plurality of relay nodes ER1-ERN according to the disclosure. This is, for example, the base station BS, the source node ES, one of the relay nodes of the plurality or even another communication node EC also attached to the BS base station.

In the following description, we will focus more specifically on the case of a group of vehicles platooning or a road convoy travelling in a road system that is at least partially automated. In this context, known as V2X (for “vehicle to anything”), the source node (or first communication node) broadcasts data to the group via a “sidelink” or SL communication channel according to the specifications of the 3GPP RAN. For example, the messages broadcast are of the CAM (Cooperative Awareness Message) type.

With this technology, the communication nodes in the same group of vehicles is attached to the same base station and forms part of the same broadcast group, i.e. the messages or data volumes exchanged are intended for the same group address. In the example shown in FIG. 1, the vehicle group comprises the source node ES, the relay nodes ER1, ER2, ER3 . . . ERN. Thanks to V2X communication, the vehicles in the leading group can accelerate or brake in unison.

The base station transmits to the nodes in the group the frequency time resources to be used to broadcast these messages. It also transmits other information useful for implementing the multi-hop transmission, such as for example the network address of a communication node incorporating a control device according to an aspect of the disclosure.

Naturally, the disclosure is not limited to this embodiment, but applies to any direct transmission, that is without passing through the base station, between a source node and a destination node by means of a plurality of relays. For simplicity, however, it is assumed that all the nodes involved are attached to the same base station.

In the embodiment described here, it is also assumed that all the communication nodes involved in the multi-hop transmission uses the same frequency band, for example 10 MHz. Naturally, this value is given by way of illustration only and does not limit the disclosure.

An aspect of the disclosure also applies to any wireless communication network, non-cellular, such as for example, a Wi-Fi network, managed by a home or professional gateway. In this case, the communication nodes implemented in the multi-hop communication obtain the information needed to implement this direct communication from the gateway. More generally, it applies to any type of network, such as a satellite network or an adhoc network of connected objects, for example of the LoRa or Sigfox type (registered trademarks).

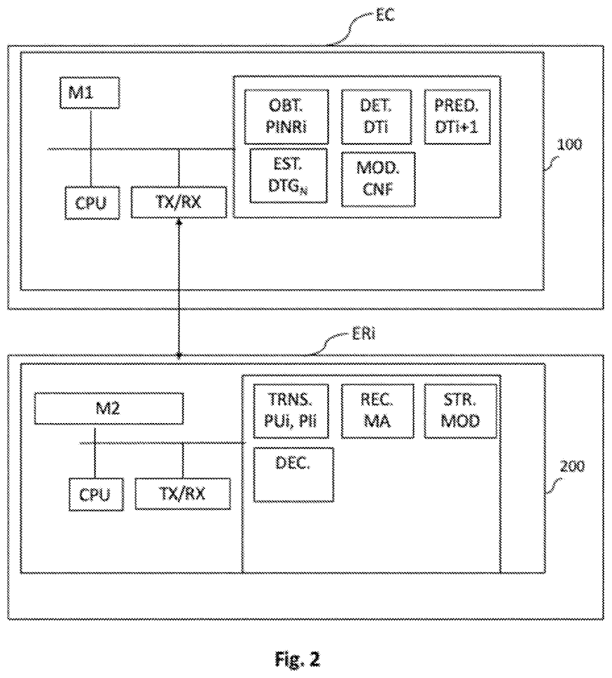

FIG. 2 shows an example of the architecture of the communication node EC according to an embodiment of the disclosure. According to this example, the communication node EC comprises a device 100 for controlling a multi-hop transmission according to an aspect of the disclosure. This device comprises at least one module OBT. PUi, PIi for obtaining from at least one relay node ERi, referred to as a current relay, said plurality ER1-ERN, located at i hops from the source node ES, with i non-null, a current strength ratio PINRi between a strength PUi of the radio signal and a noise and interference strength PIi, received and measured by said relay node, a module DET. DTi for determining an intermediate transmission delay DTi of the data volume between said source node or the preceding relay node ERi−1 placed at i−1 hops from the source node ES and said current relay node ERi, a module EST. DTG_{N} for estimating an overall transmission delay DTG_{N} of said data volume from the source node to a relay node placed at N hops, with N an integer greater than or equal to i, at least from the determined current intermediate transmission delay (DTi) and from the previously determined intermediate delays; and a modification module MOD. CNF of a multi-hop transmission configuration of the system 10, configured to be implemented when the estimated overall transmission delay reaches or exceeds a given maximum delay (for example exceeds a maximum delay allowed for multi-hop transmission).

Alternatively, the device 100 may be independent of the node EC, but connected to it by any link whatsoever, wired or not.

Advantageously, the device 100 comprises a prediction module PRED. DTi of at least one intermediate delay for at least one next relay node in relation to the current relay node ERi, this next relay node being placed between i+1 and N hops. The prediction module PRED.DTi is configured to predict the intermediate delay at least from the current strength ratio PINRi. In a particular embodiment, the device 100 also comprises a module DET. NMax for determining a maximum number of relays corresponding to a maximum value NMax of the number of hops N at which the final relay node is located, such that the overall transmission delay DTG_{N} estimated for a number of hops N equal to the maximum number NMax is less than or equal to said given maximum overall transmission delay DMax and the overall transmission delay DTG_{N} estimated for a number of hops N equal to NMax+1 is greater than said given maximum overall transmission delay DMax.

Advantageously, the device 100 comprises at least one TX/RX module for transmitting and receiving signals in the communication network and a data storage module M1. Alternatively, it uses the transmission/reception module and/or the module for storing the communication node EC into which it is integrated.

The non-volatile memory M1 advantageously includes the strength ratios received from previous relay nodes and the intermediate transmission delays determined for these previous relay nodes.

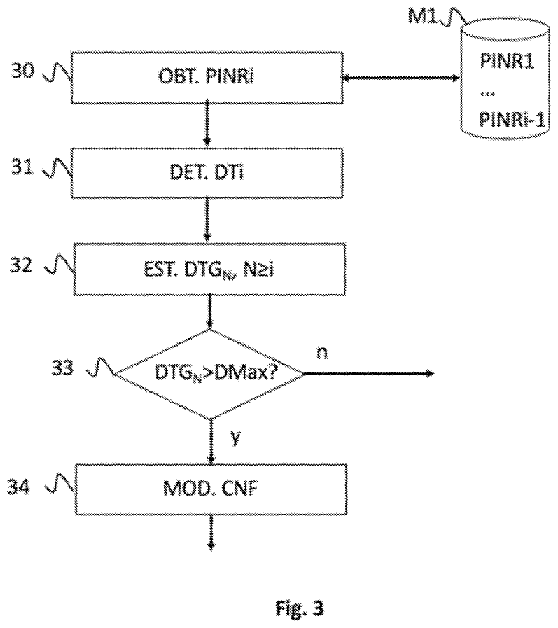

The device 100 thus implements the method for controlling a multi-hop transmission implemented by a plurality of relay nodes within a wireless communication network according to an aspect of the disclosure that will be detailed hereafter in relation to FIG. 3.

In the remainder of the description, it is assumed that this device 100 knows the relay nodes involved in the communication. For example, it has received information about these relay nodes in messages sent by means of traffic channels or common channels.

FIG. 2 also shows an example of the architecture of a relay node ERi according to an aspect of the disclosure. The relay node ERi is located i hops from source node ES, with i non-null. According to this example, the relay node ERi comprises a device 200 for processing a multi-hop transmission, in which the source node ES transmitted a radio signal carrying a useful data volume. A radio signal carrying all or part of this useful data volume is received by the relay node ERi from this source node or from a previous relay node ERi−1 located a number of hops i−1 from the source node.

The processing device 200 integrated in this relay node ERi comprises at least one transmission module TRNS. PUi, PIi of a data signal strength and a noise and interference strength it has received and measured, at a control device 100 as described above, and receive REC. MA an action message comprising a multi-hop transmission configuration modification and an order to apply this modification.

Alternatively, the device 200 may be independent of the relay node ERi, but connected to it by any link whatsoever, wired or not.

Advantageously, the processing device 200 further comprises a module STR. MOD for storing the received configuration modification and a DEC. module for deciding to apply the configuration modification comprised in the message, when it is intended for the relay node ERi.

Advantageously, the device 200 also comprises a TX/RX module for receiving and transmitting information in the wireless communication network and a data storage module M2, for example a non-volatile memory.

The device 200 thus implements the method for processing a multi-hop transmission according to an aspect of the disclosure that will be detailed hereafter in relation to FIG. 4.

In relation to FIG. 3, an embodiment of a method for controlling a multi-hop transmission in a wireless communication network, are now presented in flowchart form, according to an aspect of the disclosure. As part of this transmission, a source node ES transmitted a signal carrying a useful data volume Vol in the network. For the sake of simplicity, and for a better understanding of the disclosure, it will be assumed in the remainder of the description that this same useful data volume Vol is relayed as it is by the plurality of relay nodes. It should be noted, however, that the disclosure also applies in a context where, at each retransmission, the volume of useful data relayed by a relay node ERi may increase or decrease relative to the useful data volume Vol transmitted by the source node ES. More specifically, each relay node ERi relays to the next relay node ERi+1 a useful data volume Voli+1 comprising all or part of the useful data volume Voli received from the previous relay node ERi−1 or from the source node ES depending on the value of i, possibly completed by other useful data added by the relay node ERi.

In other words, in general, each useful data volume Voli is derived from the useful data volume Vol transmitted by the source node ES. In this case, it is assumed that the control device 100 has received information relating to this volume Voli from the relay node ERi.

For the sake of simplicity, it is also assumed that the available bandwidth W is the same for each communication node participating in the transmission, source node and relay nodes. For example, this bandwidth can be set a priori to an identical value W for all the relay nodes ERi in the system 10.

However, the disclosure is not limited to this particular case and also applies when the transmission bandwidth Wi varies from one communication node to another. In particular, it can be modified in certain contexts by the ERi relay node, for example on instruction from a user, the base station, the control device 100, etc.

In 30, a current strength ratio PINRi between a radio signal strength and a measured noise and interference strength is received from a relay node ERi, referred to as the current relay node of said plurality of relay nodes, placed at the ith hop, with i a non-null integer, of the source node ES in the multi-hop transmission implemented by the system 10.

In 31, an intermediate transmission delay DTi of the data volume during the ith hop is determined. This is the section linking the previous relay node ERi−1 to the current relay node i. Said current intermediate delay DTi is a function of said obtained strength ratio PINRi, the received data volume Vol and a transmission bandwidth W between the previous relay node and said current relay node.

In 32, an overall transmission delay DTG_{N} of said data volume from the source node ES up to a relay node placed at N hops from the source node ES, with N an integer greater than or equal to i, is estimated at least from the determined current intermediate transmission delay (DTi) and, if necessary, from the previously determined intermediate delays by previous relay nodes placed at i−1 hops and under.

In 33, the estimated overall transmission delay DTG_{N} is compared with a given maximum delay. For example, it is determined whether it is less than or equal to an authorised maximum delay DMax for multi-hop transmission. Note that it could also be compared to a delay threshold that must not be crossed, by checking whether it is strictly less than this threshold.

If the authorised maximum delay DMax is exceeded, a multi-hop transmission configuration of system 10 is modified in 34. For example, the modification includes a rule for disabling the retransmission of data from the radio signal received by a relay node ERi if it is located at a number of hops greater than or equal to a specified maximum number of relays. Another configuration example is to require the compression of the received data and/or define parameters for this compression. Yet another example consists of defining rules for selecting all or part of the data volume received, for example by deleting data that was specifically intended for the current relay node, or a priority being associated with the different data, retaining only the highest priority. Yet another example is to modify the rules for selecting one of several available routes for relaying the radio signal to a destination node and selecting the shortest in terms of transmission delay.

Optionally, the modification comprises sending an action message MA comprising at least the configuration modification and an order to apply this modification, intended for at least one communication node of the system participating in the multi-hop transmission.

When it is intended for communication nodes other than that which implements the control method according to an aspect of the disclosure, the action message is transmitted in the wireless communication network via the base station or according to a direct communication mode from one to the next, as is done by the source node ES. It should be noted, however, that when the control process is implemented by the source node or one of the relay nodes taking part in the transmission, the application of the selected configuration may include an update of the current configuration within this node without requiring such a message to be sent.

The step 32 of estimating an overall transmission delay DTG_{N} reached at the relay node ERN located N hops from the source node ES, with N greater than or equal to i, is now described in detail. This estimate is not obvious because each relay node re-amplifies the useful signal, interference and thermal noise. After N hops, the signal obtained is made up of the signal initially transmitted and re-amplified interference and noise. Estimation of the overall transmission delay therefore requires knowledge of the signal-to-noise ratio SINRi at each relay node ERi, which is advantageously made possible by an aspect of the disclosure on the basis of the information available at the relay node ERi.

In general, this delay between ES and ERN can be estimated as the sum of the intermediate delays DTi from the source node ES to the final relay node ERN:

DTG_{N}=DT1+DT2+ . . . +DTN

It is known that the transmission delay between a relay node ERi−1 and a relay node ERi can be expressed as follows:

$$\\ \begin{matrix}D {T}_{i} = \frac{{Vol}_{i}}{{W}_{i} log 2 ( 1 + S I N {R}_{i} )} & ( 1 )\end{matrix}$$

### With:

Voli the useful data volume actually received by the current relay node ERi. It may be different from the useful data volume Vol transmitted by the source node ES, Wi the bandwidth allocated to the relay node ERi;
SINRi the signal-to-noise ratio at the ERI relay node, also called ζᵢ.

Assuming Voli=VOL and Wi=W for all i, the equation (1) becomes:

$$\\ \begin{matrix}D {T}_{i} = \frac{Vol}{W log 2 ( 1 + S I N {R}_{i} )} & ( 1 bis )\end{matrix}$$

The overall transmission delay DTG_{N} can be estimated as follows:

$$\\ \begin{matrix}D T {G}_{N} = {\sum }_{i = 1}^{N} \frac{{Vol}_{i}}{{W}_{i}} \frac{1}{log 2 ( 1 + S I N R i )} & ( 2 )\end{matrix}$$

The signal-to-noise ratio SINRi depends on the current strength ratio PINRi. More precisely, there is:

$$\\ \begin{matrix}S I N R i = {ζ}_{i} = 1 + \frac{1}{{θ}_{i}} & ( 3 )\end{matrix}$$

Where θi represents the current strength ratio PINRi at the relay ERi, with PINRi=PUi/PIi, PUi being the signal strength received and measured by the relay node ERi from the previous relay node ERi−1 and
PIi is the sum of the interference strengths received and measured by the relay node ERi from all the communication nodes in system 10, to which is added the thermal noise. One therefore obtains:

$$\\ \begin{matrix}D T {G}_{N} = {\sum }_{j = 1}^{N} \frac{{Vol}_{i}}{{W}_{i}} \frac{1}{log 2 ( 1 + \frac{1}{{\prod }_{i = 1}^{j} ( 1 + \frac{1}{θ i} ) - 1} )} & ( 4 )\end{matrix}$$

In the remainder of the description, it is assumed that the data volume Vol transmitted by the system remains the same throughout the transmission and that the bandwidth W is identical for each of the communication devices of the system.

In this case, where Wi=W and Voli=Vol for all i, the expression for the overall transmission delay can be simplified as follows:

$$\\ \begin{matrix}D T {G}_{N} = \frac{Vol}{W} {\sum }_{j = 1}^{N} \frac{1}{log 2 ( 1 + \frac{1}{{\prod }_{i = 1}^{j} ( 1 + \frac{1}{θ i} ) - 1} )} & ( 4 bis )\end{matrix}$$

At this stage, there are at least three different embodiments of the disclosure:
a first mode, referred to as “upstream”, according to which the process is implemented before the actual transmission of the data volume Vol by the source node ES, from strengths obtained from the relay nodes ER1-ERN for the transmission of a pilot or previous data volume to one or more destination nodes. This first mode enables the configuration of the source node and possibly the plurality of relay nodes ER1-ERN to be adjusted.
a second mode, referred to as “on the fly”, in which the overall transmission rate DTG_{N} is estimated from the strength ratios as they are obtained. In other words, N=i and the final relay node ERN corresponds to the current relay node ERi. This method makes it possible to modify the system's multi-hop transmission configuration with a view to transmitting a next volume data Vol′; and
a third mode, known as “anticipatory”, in which N is strictly greater than i and the transmission rate is estimated not only on the basis of the current and previous strength ratios, but also on the basis of strength ratios predicted for relay nodes located at i+1 hops and more from the source node ES. This method allows the configuration of the relay node ERi+1-ERN located downstream of the current relay node to be adjusted relative to the source node ES during transmission of the data volume Vol.

According to the first embodiment, the overall transmission delay DTG_{N} of the useful data volume Vol to the final relay node ERN, which is the destination node in this case, is estimated in 32 using the equation 4 bis. In this first embodiment, the number N is fixed, for example.

In 33, it is compared with the maximum authorised transmission delay DMax and verified, in the case where the data volume Vol is unchanged during transmission and the transmission bandwidth W is constant, that

$$\\ \begin{matrix}D T {G}_{N} = \frac{Vol}{W} {\sum }_{j = 1}^{N} \frac{1}{log 2 ( 1 + \frac{1}{{\prod }_{i = 1}^{j} ( 1 + \frac{1}{θ i} ) - 1} )} \leq D Max & ( 5 )\end{matrix}$$

If this condition is met, no configuration change is decided.

On the contrary, if it is not verified, a modification of the transmission configuration of one or more communication nodes of the system is modified.

For example, this is a new configuration for the source node ES and the current configurations of the relay nodes ER1-ERN are unchanged. For example, this new configuration defines new route selection rules and/or a maximum number of authorised relays.

Alternatively or in combination, configuration modifications are decided for the relay node ER1-ERN in 34 and one or more action messages MA comprising these new configurations are transmitted to them in 35 in the wireless communication network. They can be sent specifically to each of the relay nodes concerned or even to all of them, in which case each relay node is configured to decide if it must apply the configuration received in the message. This aspect will be detailed in relation to FIG. 4.

According to another option, when the control process is implemented by the source node ES, the configuration modifications are transmitted to the communication nodes of the system with a next data volume Vol′ that it transmits within the multi-hop transmission system. According to the second embodiment, the overall transmission delay DTGi up to the relay node ERi is also estimated in 32 using the equation 4 bis. In this second embodiment, the number N is fixed, for example.

In 33, it is compared with the maximum authorised transmission delay DMax and verified, in the case where the data volume Vol is unchanged during transmission and the transmission bandwidth W is constant, that

$$\\ \begin{matrix}D T {G}_{N} = \frac{Vol}{W} {\sum }_{j = 1}^{N} \frac{1}{log 2 ( 1 + \frac{1}{{\prod }_{i = 1}^{j} ( 1 + \frac{1}{θ i} ) - 1} )} \leq D Max & ( 5 )\end{matrix}$$

If this condition is met, no configuration change is decided.

On the contrary, if it is not verified, a modification of the multi-hop transmission configuration of one or more relay nodes located at i hops and more is decided in 34 and an action message MA comprising this configuration modification is transmitted in 35 in the wireless communication network, at least to the relevant relay nodes.

According to the third implementation mode, known as “anticipatory”, N is chosen to be strictly greater than i and there is an interest in determining N to respect a constraint on the overall transmission delay in relation to the maximum authorised transmission delay. To estimate the overall transmission delay DTG_{N} up to the final relay node ERN, the intermediate transmission delays corresponding to the hops between i+1 and N for which the strength ratios PINRi+1-PINRN have not yet been obtained are predicted from the current strength ratio PINRi and possibly previous ones stored in memory. For example, it is assumed that PINRi+1=PINRi+2= . . . PINRN=PINRi=θi. The overall transmission delay DTG_{N} up to the final relay node ERN is obtained using the equation 4 bis and compared in 33 with the authorised maximum delay DMax in 33 as in the previous case.

If it is strictly less than the authorised maximum delay DMax, it is advantageous to increment the value of N by one unit and repeat the estimation for N=N+1 as previously described, compare the result obtained with the authorised maximum delay, and continue in this way until the overall transmission delay DTG_{N} exceeds the authorised maximum delay. The last value of N which does not exceed the authorised maximum delay then corresponds to the maximum number NMax of hops and therefore of relays authorised to retransmit the data volume Vol transmitted by the source node ES by the multi-hop transmission system while ensuring the constraint on the authorised maximum delay.

The advantage of this anticipatory mode is that it is possible to modify the multi-hop transmission configuration of relay nodes located at i+1 hops and more from the current relay node, before they receive the data carrier signal transmitted by the source node ES, and therefore with greater impact.

On the other hand, determining the maximum allowed number of relays NMax enables simple and effective control of the system relay nodes used in the multi-hop transmission. Indeed, such control can be achieved by configuring a deactivation of the retransmission of the radio signal received from the source node and commanding its execution by all the relay nodes located at NMax hops and more from this source node, and thus guaranteeing that the given maximum transmission delay DMax will not be exceeded.

Within this third embodiment, we now consider the special case where all the relay nodes ER1-ERN are assumed to have the same PINRi strength ratio. In particular, the implementation of the control process according to an aspect of the disclosure is considered for i=1. The control device 100 obtains the strength ratio PINR1 and predicts the following strength ratios PINR2-PINR_{N} as being equal to PINR1=θ.

In this case, the previous equations can be simplified as follows:

$$\\ \begin{matrix}D T {G}_{N} = \frac{Vol}{W} {\sum }_{i = 1}^{N} \frac{1}{log 2 ( 1 + \frac{1}{{ξ}^{{}_{} i} - 1 )}} with ξ = 1 + \frac{1}{θ} ) & ( 4 {bis}^{{}_{} ′} )\end{matrix}$$

This gives:

ξⁱ⁺¹>ξⁱ (6)

hence

$$\\ \begin{matrix}\frac{1}{{ξ}^{{}_{} i} - 1} > \frac{1}{{ξ}^{{}_{} i + 1} - 1} & ( 7 )\end{matrix}$$

It can be deduced from this that the intermediate transmission delay DTi on a link corresponding to the hop i between the relay node ERi−1 and the relay ERi is less than the transmission delay on the link corresponding to the hop i+1 between the relay ERi and the relay ERi+1.

As a result, the intermediate transmission delays between the source node ES and the final relay node ERN increase:

DT₁<DT₂< . . . <DT_{N} (8)

If a relay node ERi can retransmit without delay and from reception of the 1^{st} byte to the next relay node ERi+1, the data it receives from the previous relay ERi−1, for example because they use separate frequency bands, then one obtains:

DTG₂=DT₁+D₁₂=max(DT₁; DT₂)=DT₂

If one generalises, one obtains:

DTG_{N}=DT₁+D₁₂+ . . . +DT_{N}=max(DT₁; DT₂, . . . , DT_{N})=DT_{N}

Thus, the condition on the overall transmission delay DTG_{N} becomes:

$$\\ \begin{matrix}D T {G}_{N} = \frac{Vol}{W} {\sum }_{i = 1}^{N} \frac{1}{log 2 ( 1 + \frac{1}{{ξ}^{{}_{} i} - 1} )} \leq D Max & ( 9 )\end{matrix}$$

This therefore gives:

$$\frac{V}{W} \frac{1}{log 2 ( 1 + \frac{1}{{ξ}^{N} - 1} )} \leq D Max \qquad ( 10 )$$

One applies:

$$a = \frac{Vol}{W \cdot D Max}$$

Where DMax is the given or authorised maximum delay.

The previous condition can be translated as follows:

$$a \leq log 2 ( 1 + \frac{1}{{ξ}^{N} - 1} )$$

This therefore gives:

$${2}^{a} - 1 \leq \frac{1}{{ξ}^{N} - 1}$$

Hence

$${ξ}^{N} - 1 \leq \frac{1}{{2}^{a} - 1}$$

Hence

$${ξ}^{N} \leq \frac{1}{{2}^{a} - 1} + 1$$

That is

$$( N ) log ( ξ ) \leq log ( \frac{1}{{2}^{a} - 1} + 1 )$$

Hence

$$N \leq \frac{log ( \frac{1}{{2}^{a} - 1} + 1 )}{log ( ξ )}$$

Hence

$$N \leq \frac{a - log 2 ( {2}^{a} - 1 )}{log 2 ( ξ )} \qquad ( 11 )$$

As previously mentioned, NMax designates the authorised maximum number of relays to guarantee the authorised maximum delay constraint DMax, in other words, NMax is the maximum value of N such that

DTG_{N}≤DMax

It follows from this, and from the inequality (11), that:

$$N Max = ⌊ \frac{a - log 2 ( {2}^{a} - 1 )}{log 2 ( ξ )} ⌋ \qquad ( 11 b )$$

Where └ ┘ designates the integer part.

This gives a precise analytical expression for the authorised maximum number of relays. For example, for a data volume Vol=1 Kb and a bandwidth W=1 MHZ, a strength ratio θ=0.8, the signal-to-noise ratio is ξ=2.25, V=1 kbits, W=1 MHz and one obtains: for DMax fixed at 10 s, NMax=10 relay nodes; for DMax fixed at 1 s, NMax=7 relay nodes.

A description has just been given for an embodiment in which the following simplifying assumptions have been made:
the useful data volume Vol relayed remains constant throughout the multi-hop transmission,
the bandwidth West is constant within the multi-hop transmission system,
each relay node in the system retransmits received data from a previous relay node without delay.

Naturally, the disclosure is not limited to this particular case, but also applies in the general case. Based on equations (4) and (5), we can derive an analytical expression for the overall delay DTG_{N} based on considerations similar to those used in this particular example. Note that if the analytical expression of the overall transmission delay is too complex to allow analytical resolution, a numerical method, easily executable by computer, can be used to obtain the maximum number of relays allowed. Such a method consists, for example, in implementing a simple algorithm comprising a loop for testing successive values of the number of hops N and an exit from the loop as soon as the given condition on the maximum delay DMax is no longer met.

An example of the implementation by a relay node in a wireless communication network of a method for processing a multi-hop transmission implemented in this wireless communication network is now presented in relation to FIG. 4, in the form of a flowchart. It is assumed that this is a relay node of the system 10, for example of the relay node ERi located at i hops, with i a non-null integer, from the source node ES having transmitted the useful data volume Vol in the framework of the multi-hop transmission. For example, this method is implemented by the processing device 200.

In 40, the relay node ERi receives a radio signal carrying all or part of the useful data volume Vol transmitted by the source node ES, from this source node if i=1 and from a previous relay node ERi−1 if i>1.

In 41, the relay node ERi measures a strength PUi of the radio signal received from the source node or the previous relay node and a strength PIi of the interference received from all the communication nodes located in proximity, to which thermal noise is added.

In 42, it transmits the measured strengths PUi and PIi to a control device 100 according to an aspect of the disclosure.

It is assumed that it knows the network address of this device 100 because it has previously obtained it from the base station BS, or that it transmits the strengths to the base station, which then sends them back to the control device 100.

In 43, it receives an action message MA from the control device 100. This message includes at least one modification to the multi-hop transmission configuration of the system 10 and an application order intended for one or more relay nodes in this system.

In 44, it stores the configuration modification.

According to a particular embodiment, the configuration modification comprises a maximum number of relays NMax and the application order is intended for the relay nodes located at NMax hops and more from the source node ES.

For example, the configuration includes a maximum number of relays NMax and a rule for disabling the retransmission of the received data volume, and the application order relates to the relay nodes located at NMax hops and more from the source node ES.

Advantageously, the maximum number of relays NMax received is stored in memory in 44.

In 45, it is compared with the number of hops i of the relay node ERi and decided if the received retransmission configuration modification should be executed according to the result of this comparison. If i is greater than or equal to NMax, device 200 modifies its current configuration using the new configuration received, which becomes applicable to the next data it receives from a previous relay node within the framework of the multi-hop transmission.

There are at least the following two cases:
according to a first case, the reception in 40 of the data signal from the source node precedes reception in 43 of the action message MA. The ERi relay node therefore knows its number of hops i in the multi-hop transmission, so it can decide immediately in 45 whether to execute the action included in the message and do so if necessary,
according to a second case, the reception in 40 of the data signal from the source node follows the reception in 43 of the action message MA. It is assumed that the relay node does not yet know its hop count in the multi-hop communication. In 44, it stores in memory the number of hops NMax and the retransmission configuration received in the action message and waits to receive the radio signal in 40. On receipt, it triggers the step 45 of deciding whether or not to execute the action received.

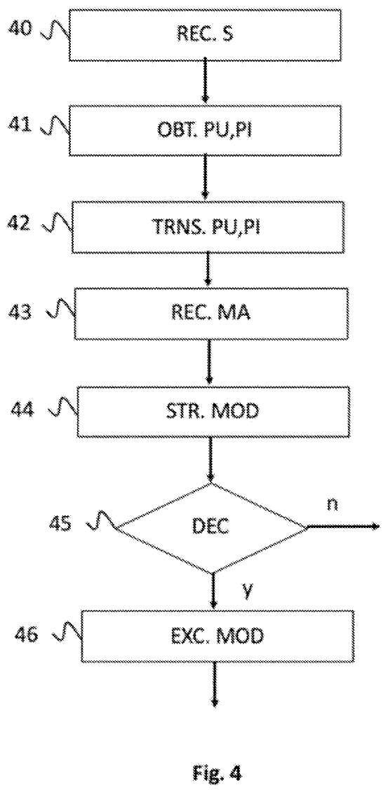

Another example of the hardware structure of a device 100 for controlling a multi-hop transmission implemented by a system in a wireless communication network according to an aspect of the disclosure is now presented in relation to FIG. 5, said system comprising a source node configured to transmit a radio signal carrying a data volume and a plurality of relay nodes configured to receive, amplify and retransmit a radio signal received from another relay node or from the source node. According to this example, the control device 100 comprises, as illustrated in FIG. 2, at least one module for obtaining, one module for determining, one module for estimating and one module for modifying a multi-hop transmission configuration of the system.

The term “module” can correspond to a software component as well as to a hardware component or a set of hardware and software components, a software component itself corresponding to one or more computer programs or sub-programs, or more generally, to any element of a program capable of implementing a function or set of functions.

More generally, such a device 100 comprises a random access memory 103 (for example, a RAM memory), a processing unit 102 equipped for example with a processor and controlled by a computer program Pg, representative of the modules for obtaining, determining, estimating, selecting and applying, stored in a read-only memory 101 (for example, a ROM memory or hard disk). At initialisation, the code instructions of the computer program are for example loaded into a random access memory 103 before being executed by the processor of the processing unit 102. The random access memory 103 can also include the determined intermediate transmission delays, as well as the strength ratios obtained from the strengths measured by the relay nodes.

FIG. 5 only shows a particular one of several possible ways of realising the device 100, so that it executes the steps of the method for controlling a multi-hop transmission in a wireless communication network as detailed above, in relation to FIG. 3 in its different embodiments. Indeed, these steps may be implemented indifferently on a reprogrammable computing machine (a PC computer, a DSP processor or a microcontroller) executing a program comprising a sequence of instructions, or on a dedicated computing machine (for example a set of logic gates such as an FPGA or an ASIC, or any other hardware module).

In the case where the device 100 is realised with a reprogrammable computing machine, the corresponding program (that is the sequence of instructions) can be stored in a removable (such as, for example, an SD card, a USB flash drive, CD-ROM or DVD-ROM) or non-removable storage medium, this storage medium being partially or totally readable by a computer or a processor.

The various embodiments have been described above in relation to a device 100 integrated into a communication node of the network, for example the source node ES, the base station BS or one of the relay nodes of the system, but it can also be independent of the communication node in question and connected to it by any link.

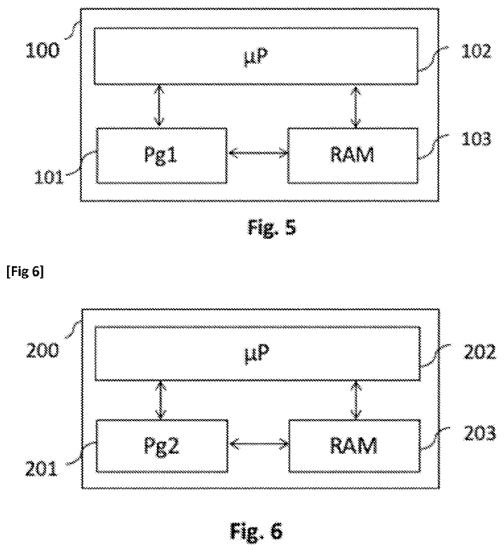

Also shown, in relation to FIG. 6, is another example of the hardware structure of a device 200 for processing a multi-hop transmission in a wireless communication network according to aspect of the disclosure, comprising, as illustrated by the example in FIG. 2, at least one module for transmitting and one module for receiving an action message. The term “module” can correspond to a software component as well as to a hardware component or a set of hardware and software components, a software component itself corresponding to one or more computer programs or sub-programs, or more generally, to any element of a program capable of implementing a function or set of functions.

More generally, such a device 200 comprises a volatile memory 203 (for example, a RAM memory), a processing unit 202 equipped for example with a processor and controlled by a computer program Pg2, representative of the transmission and reception modules, stored in a read-only memory 201 (for example, a ROM memory or hard disk). At initialisation, the code instructions of the computer program are for example loaded into a random access memory 203 before being executed by the processor of the processing unit 202.

FIG. 6 only shows a particular one of several possible ways of realising the device 200, so that it executes the steps of the processing method as detailed above, in relation to FIG. 4 in its various embodiments. Indeed, these steps may be implemented indifferently on a reprogrammable computing machine (a PC computer, a DSP processor or a microcontroller) executing a program comprising a sequence of instructions, or on a dedicated computing machine (for example a set of logic gates such as an FPGA or an ASIC, or any other hardware module).

In the case where the device 200 is realised with a reprogrammable computing machine, the corresponding program (that is the sequence of instructions) can be stored in a removable (such as, for example, an SD card, a USB flash drive, CD-ROM or DVD-ROM) or non-removable storage medium, this storage medium being partially or totally readable by a computer or a processor.

The disclosure that has just been described in its different embodiments has many advantages. Generally speaking, it applies to a group of objects connected in a wireless communication network, such as a line of vehicles, which transmit information from one to the next in a direct, multi-hop communication mode, or machines on the same production line.

An aspect of the disclosure proposes to estimate an overall transmission delay for data sent by a source connected object to one or more destination connected objects by means of a plurality of relay connected objects on the basis of strengths measured by these relays, without the need for a calculation from one to the next. An aspect of the disclosure then uses this estimate to control the multi-hop transmission by modifying the retransmission configuration of the communication nodes of the system implementing this transmission, which enables it to ensure that the delay in transmitting this data does not exceed a given maximum delay, for example authorised. In particular, an aspect of the disclosure makes it possible to avoid the reception, and therefore the consideration by the destination node or nodes, of data that has become obsolete as a result of too high a latency.

An aspect of the disclosure improves the situation with respect to the prior art.

In particular, an aspect of the disclosure meets the need to guarantee that an information transmission delay constraint between the source node and a destination node, whether the latter is identified a priori or not, is satisfied.

Although the present disclosure has been described with reference to one or more examples, workers skilled in the art will recognize that changes may be made in form and detail without departing from the scope of the disclosure and/or the appended claims.

1. A control method comprising:
controlling a multi-hop transmission in a wireless communication network, said transmission being implemented by a system comprising a source node and a plurality of relay nodes configured to receive, amplify and retransmit a radio signal transmitted by the source node, wherein said controlling is implemented by a control device and comprises, for a current relay node of the plurality of relay nodes, placed at i hops from the source node, with i being a non-null integer:
obtaining for said current relay node a current strength ratio between a strength of the radio signal and a noise and interference strength received by said current relay node;
determining a current intermediate transmission delay of useful data carried by said radio signal between said source node or a previous relay node located at i−1 hops and said current relay node, said current intermediate delay being a function of said obtained current strength ratio, a useful data volume received by said current relay node and a transmission bandwidth of the volume between the source node or the previous relay node and said current relay node;
estimating an overall transmission delay of the radio signal from the source node to a final relay node located at a number of hops N, with N being an integer greater than or equal to i, at least from the determined current intermediate transmission delay and at least one intermediate delay previously determined for a relay node located at i−1 hops or less from the source node; and
in response to the estimated overall transmission delay reaching or exceeding a given maximum delay, modifying a multi-hop transmission configuration of the system.

2. The control method according to claim 1, wherein the estimation of the overall transmission delay of said radio signal from the source node to the final relay node placed at the number of hops N is implemented once the strength ratios have been obtained and the intermediate transmission delays have been determined for the plurality of relay nodes participating in the transmission and wherein the modification of the configuration is applied for transmission of a next radio signal by the source node.

3. The control method according to claim 1, wherein the estimation of the overall transmission delay of said radio signal from the source node to the final relay node located at the number of hops N is implemented following the strength ratio being obtained and the determination of the intermediate transmission delay for the current relay node, and wherein the modification of the configuration comprises sending an action message comprising at least the modified configuration and an order for application of said configuration by at least one relay node located at i+1 hops and more from the source node.

4. The control method according to claim 3, wherein, N is greater than i, and said method comprises predicting at least one intermediate delay for at least one next relay node, placed between i+1 and N hops, at least from the current strength ratio or from a strength ratio stored in memory for said next relay node, and wherein the estimation of the overall transmission delay takes into account the predicted intermediate delays.

5. The control method according to claim 3 wherein:
the method comprises determining a maximum number of relays corresponding to a maximum value (NMax) of the number of hops N at which the final relay node is located, such that a predetermined condition is satisfied, said condition being that the estimated overall transmission delay for a number of hops N equal to the maximum value NMax does not reach the maximum delay and the estimated overall transmission delay for a number of hops equal to NMax+1 reaches or exceeds said maximum delay; and wherein:
the modified configuration includes the maximum number of relays and a prohibition to retransmit the radio signal received from the source node for a relay node located at a hop number greater than said maximum number of relays.

6. The control method according to claim 1, wherein the relay nodes of said plurality transmit on a same frequency band and the estimation of the overall transmission delay comprises a summing of the intermediate transmission delays between the relay nodes placed at N hops and less from the source node.

7. The control method according to claim 6, wherein the overall transmission delay is expressed as follows:
$$D T G = {\sum }_{i = 1}^{N} \frac{{Vol}_{i}}{{W}_{i}} \frac{1}{log 2 ( 1 + S I N {R}_{i} )}$$
where Voli is the useful data volume received by the current relay node (ERi);
Wi is the transmission bandwidth available at the current relay node (ERi);
N is the number of hops at which the final relay node is placed; and
SINRᵢ represents a signal to interference and noise ratio at the relay node placed at i hops for the radio signal received from the previous relay node (ERi−1).

8. The control method according to claim 5, wherein the determination of the maximum number of relays (NMax) comprises iterating a step of incrementing the number of hops N by one unit, and the step of estimating an overall transmission delay for the final relay node, as long as the predetermined condition is not met.

9. The control method according to claim 2, wherein, for i equal to 1, the intermediate transmission delays of the relay nodes located 2 hops and more from the source node are predicted as equal to the current strength ratio and the overall transmission delay up to a final relay node located at N hops is calculated from a signal-to-noise ratio at the relay node located at i hops defined as follows:
$$D T G = {\sum }_{i = 1}^{N} \frac{{Vol}_{i}}{{W}_{i}} \frac{1}{log 2 {( 1 + S I N {R}_{i} )}^{′}} \\ where S I N {R}_{i} = \frac{1}{{ζ}^{i} - {1}^{′}}$$
Voli is the data volume received by the current relay node (ERi), Wi is the transmission bandwidth at the current relay node (ERi), and
$$ζ = 1 + \frac{1}{θ}$$
where θ is the strength ratio obtained by the relay node (ER1) placed at one hop from the source node.

10. The control method according to claim 9, wherein:
the estimation of the overall transmission delay of said radio signal from the source node to the final relay node located at the number of hops N is implemented following the strength ratio being obtained and the determination of the intermediate transmission delay for the current relay node, and wherein the modification of the configuration comprises sending an action message comprising at least the modified configuration and an order for application of said configuration by at least one relay node located at i+1 hops and more from the source node;
the method comprises determining a maximum number of relays corresponding to a maximum value (NMax) of the number of hops N at which the final relay node is located, such that a predetermined condition is satisfied, said condition being that the estimated overall transmission delay for a number of hops N equal to the maximum value NMax does not reach the maximum delay and the estimated overall transmission delay for a number of hops equal to NMax+1 reaches or exceeds said maximum delay; and wherein:
the modified configuration includes the maximum number of relays and a prohibition to retransmit the radio signal received from the source node for a relay node located at a hop number greater than said maximum number of relays; and
the overall transmission delay is estimated as the intermediate transmission delay (DTi) of the relay node having the maximum value and in that the authorised maximum number (NMax) is calculated as follows:
$${N}_{Max} = ⌊ \frac{a - log 2 ( {2}^{a} - 1 )}{log 2 ( ξ )} ⌋ ,$$
where └ ┘ designates the integer part, with
$$a = \frac{Vol}{{WD}_{Max}}$$
where Dmax represents the given maximum delay, V the useful data volume carried by the radio signal transmitted by the source node, and W the transmission bandwidth available for the multi-hop transmission.

11. A processing method comprising:
processing multi-hop transmission in a wireless communication network, said transmission being implemented by a system comprising a source node and a plurality of relay nodes configured to receive, amplify and retransmit a radio signal transmitted by the source node, wherein said processing is implemented by a device and comprises, for a current relay node of the plurality of relay nodes, placed at i hops from the source node, with i being a non-null integer:
transmitting to a control device of the wireless communication network at least one strength of a radio signal and a noise and interference strength received by said current relay node; and
receiving from said control device of an action message comprising at least one multi-hop transmission configuration modification of said system and an order to apply said modification, said configuration modification comprising at least a maximum number of relays greater than or equal to i and a rule for disabling retransmission of the radio signal received from the source node for a relay node located at a hop number greater than or equal to said maximum number of relays.

12. The processing method according to claim 11, wherein the method further comprises deciding to execute the application order included in the message when the number of hops i from the relay node is greater than the maximum number of relays (NMax) received.

13. A device for controlling a multi-hop transmission in a wireless communication network, said transmission being implemented by a system comprising a source node and a plurality of relay nodes configured to receive, amplify and retransmit a radio signal transmitted by the source node, wherein said device comprises:
at least one processor; and
at least one non-transitory computer readable medium comprising instructions stored thereon which when executed by the at least one processor configure the device to implement, for a current relay node of the plurality of relay nodes, placed at i hops from the source node, with i being a non-null integer:
obtaining for said current relay node a current strength ratio between a strength of the radio signal and a noise and interference strength received and measured by said current relay node;
determining a current intermediate transmission delay of useful data carried by said radio signal between said source node or the previous relay node and said current relay node, said current intermediate delay being a function of said obtained current strength ratio, a useful data volume received by said current relay node and a transmission bandwidth of the volume between the source node or the previous relay node and said current relay node;
estimating an overall transmission delay of the radio signal from the source node to a final relay node located at a number of hops N, with N being an integer greater than or equal to i, at least from the determined current intermediate transmission delay and at least one intermediate delay previously determined; and
in response to the estimated overall transmission delay reaching or exceeding a given maximum delay modifying a multi-hop transmission configuration of said system.

14. A device for controlling a multi-hop transmission in a wireless communication network, said transmission being implemented by a system comprising a source node and a plurality of relay nodes of the wireless communication network, configured to receive, amplify and retransmit a radio signal transmitted by the source node, wherein said device comprises:
at least one processor; and
at least one non-transitory computer readable medium comprising instructions stored thereon which when executed by the at least one processor configure the device to implement, for a current relay node of the plurality of relay nodes, placed at i hops from the source node, with i being a non-null integer:
transmitting to a control device of the wireless communication network at least one strength of a radio signal and a noise and interference strength received and measured by said current relay node; and
receiving from said control device of an action message comprising at least one modification of a multi-hop transmission configuration of said system and an order to apply said modification, said configuration modification comprising at least a maximum number of relays greater than or equal to i and a rule for disabling retransmission of the radio signal received from the source node for a relay node located at a hop number greater than or equal to said maximum number of relays.

15. (canceled)
